(19) United States
(12) Patent Application Publication
(10) Pub. No.: US 2014/0224465 A1
(43) Pub. Date: Aug. 14, 2014

(54) HYDROPHILIC POLYMER THERMAL BARRIER SYSTEM

(71) Applicants: ERIC ANDRASI, KEMPTVILLE (CA); STEVE CARKNER, OTTAWA (CA)

(72) Inventors: ERIC ANDRASI, KEMPTVILLE (CA); STEVE CARKNER, OTTAWA (CA)

(21) Appl. No.: 13/765,516

(22) Filed: Feb. 12, 2013

(51) Int. Cl. H01M 10/50

(52) U.S. Cl. CPC H01M 10/5087
USPC 165/185

(57) ABSTRACT

A hydrophilic polymer thermal barrier system is described for preventing thermal runaway propagation from a faulted cell to an un-faulted cell in a battery pack. The thermal barrier system comprises a thermal barrier disposed between each of the battery cells and optionally between the battery cells and the battery pack housing. The thermal barrier cross-sectional area is at least equal to an adjacent battery cell. The thermal barrier contains a thermal absorbing material in a sufficient quantity to absorb heat released from a faulted battery.

### RELATED APPLICATIONS

This application claims the benefit of U.S. Provisional Patent Application 61/610,146 for the same invention filed by the same inventors in the USPTO on Mar. 13, 2012

### FEDERAL FUNDING

N/A

### BACKGROUND OF THE INVENTION

1. Field of the Invention

This invention pertains to the field of batteries, and particularly to a thermal barrier system that resides between neighbouring cells of a battery pack in order to prevent propagation of thermal runaway through the cells of a battery pack.

2. Discussion of the Problem

A battery is generally constructed from one or more individual electrochemical cells. Such cells may be manufactured using a variety of systems including metal cylinders such as industry standard “AA” batteries or plastic jars such as the lead-acid batteries found in automobiles.

Pouch cells are generally constructed by enclosing a flat laminate structure of electrodes within a pouch which is then sealed. These pouch cells may be referred to in the industry as polymer cells, flat cells or laminate cells.

Pouch cell technology may also be applied in other areas such as the construction of super-capacitors and may be employed in future energy storage technology packaging such as carbon-tube, nano-wire, and other means that may be ionic, electrostatic or electrochemical in nature.

In general, when energy is stored in a small space, the greater the energy stored, the higher the potential for a thermal event, such as fire, if the energy is released at a rate that is much higher than the system was designed for. For example, in the case of a Lithium Polymer rechargeable cell, if the cell is short circuited, it may develop very high internal temperatures to the cell. The connections and the shorting element may also get very hot with the shorting element becoming red or even white-hot during the event. External short circuits can be protected to some extent by using battery management electronics, fusible links and current-limiting materials in the cell construction. However, energy storage cells can also develop internal short circuits. This includes penetration of the cell by a foreign object such as a nail or a bullet, and can also include dendrite growth or manufacturing defects that will cause the conductive electrodes inside the cell to short together. These internal short circuits can cause the cell to become extremely hot and will sometimes result in thermal runaway of the energy storage system.

Thermal runaway is a condition where a reaction becomes exothermic to the point where it becomes self-sustaining and may even accelerate. When a lithium cell is shorted, it can reach temperatures in excess of 200° C. For some chemistries, a temperature of 200° C. will result in chemical reactions that produce heat at a rate that cannot be dissipated by the cell surface, as a result the cell temperature may rise beyond that temperature that would be caused purely by the discharge of the electrical energy in the cell, this can cause the cell temperature to rise far beyond the 200° C., this is thermal runaway. The temperatures given are as an example only, the actual temperature a cell reaches when shorted and the temperature at which thermal runaway occurs will vary based on many conditions including the cell composition, charge level, age, environmental conditions, fault condition and packaging.

In some cases, a cell may also generate flammable gasses when it reaches very high temperatures. The self-generation of gasses such as hydrogen and oxygen, coupled with high point source temperatures and possibly sparking, can also result in ignition of the system. Many batteries contain large amounts of carbon and other materials that will readily burn in the presence of these gasses, as such the reaction may move from one of thermal runaway to complete system combustion.

The faulted cell can become so hot that, when such cell is part of a battery assembly of multiple cells, the heat from the faulted cell will bring neighbouring cells up to a temperature where they too enter thermal runaway, even if those cells have no faults. These neighbouring cells may then become so hot that in turn they cause other cells to enter thermal runaway, with the end result of the entire battery package entering thermal runaway.

A common method for preventing thermal runaway from propagating from cell to cell within a battery pack is to include some form of separator between cells that will thermally insulate the cells, such as fibreglass. The advantage of insulation is that it can be light weight and inexpensive. However, the major disadvantage of such material is that the cell cannot easily dissipate heat generated during normal operation. For this reason, use of thermally insulating materials between the cells may actually increase the probability of thermal runaway, especially in high-power battery packs that tend to generate significant heat when operating normally.

Metal jackets or separators have been suggested as a method for removing heat from battery packs. A thermally conductive material such as aluminum is placed between the cells and will absorb and transmit heat. In some cases the jacket is filled with pumped coolant that flows to a reservoir and heat dissipater. The disadvantage of metallic systems is the excessive weight and cost of implementing such a system. In addition, metal systems are conductive and therefore can increase foreign object short-circuit potential during penetration, for example if struck by a bullet. A metal separator between cells may also increase conduction of heat between cells and can therefore promote thermal runaway by conducting very high temperatures from a faulted cell to a non-faulted cell.

The inclusion of flowing coolant further increases complexity, cost and system weight and also contributes to an overall decrease in system efficiency due to the power required for pumps.

Thermally conductive systems which preferentially transmit heat in one direction only have been promoted as a compromise method to draw heat away from the cells, while preventing heat transfer between the cells. These systems suffer from high weight, complexity and cost, and typically they have poor thermal conductivity in the desired direction when compared to metals.

The use of materials that transition from a solid to a liquid have also been suggested for use as cell separator materials. These solid phase change materials are often composed of wax, carbon, or other chemicals with transition temperatures in the order of 40° C. to 60° C. These materials absorb on the order of 50 to 300 J/g of energy during the transition phase. While such materials can absorb peak temperatures produced during normal operation, they provide no protection against thermal runaway if the battery system is operating above their transition temperature. In addition, the materials used will contribute to thermal runaway in situations where flame is involved, in effect the materials designed to absorb heat may actually add fuel to the fire in extreme thermal runaway conditions.

Solid materials do not absorb much energy when compared to the amount of energy stored in a lithium battery. As lithium batteries increase in energy density the amount of solid phase change materials required may actually exceed the original weight of the cells. For example, a lithium battery may have an energy density of 200 watt-hours-per-kilogram. A single gram of material is therefore capable of releasing 720 joules of energy. If the phase change material is only capable of absorbing 100 joules per gram, then 7.2 grams of material will be required to absorb the energy for every gram of battery. This increases the weight of the battery system by more than 700%.

Battery systems may also be exposed to fire in situations where neighbouring equipment that is not associated with the battery catches on fire. In such situations, it is important that the battery, to the greatest extent possible, should resist catching on fire, and if it does catch on fire, it is desired that the battery contribute as little additional energy or fuel to said fire.

There remains a need for a system that can absorb all of the energy released by an energy storage cell that is faulted to prevent the cell from entering thermal runaway, there further exists a need for a system that can absorb transient thermal heat from an energy storage cell during normal operation, there further exists a need for a thermal barrier system that can prevent thermal runaway propagation from cell to cell in a battery pack, there further exists a need for a thermal barrier system that is light weight and inexpensive, there further exists a need for a thermal barrier system that will not contribute significantly to the energy released during a combustion event in the case where a battery system is on fire.

### SUMMARY OF THE INVENTION

In order to overcome the deficiencies noted above, we propose as a solution our invention, namely, a system which includes hydrophilic material disposed within a hydrophobic material and placed within a battery.

Hydrophilic polymers contain polar or charged functional groups, rendering them soluble in water. Most hydrophilic polymers are grouped by the chemistry of their structure. For example, acrylics include acrylic acid, acrylamide, and maleic anhydride polymers and copolymers. Amine-functional polymers include allylamine, ethyleneimine, oxazoline, and other polymers containing amine groups in their main- or side-chains. A hydrophilic polymer that has been mixed with water will often be referred to as a hydrogel.

In a preferred embodiment, sodium polyacrylate is used as the hydrophilic substance and will be mixed at a ratio of about 1 part sodium polyacrylate to 99 parts water. It is a hydrophilic, or water loving, polymer and can hold up 500 times its weight in water. Polymers are long chains of molecules linked together. The sodium polyacrylate forms chains around the water molecules and holds onto them like a net creating a hydrogel. A suitable ratio of water to sodium polyacrylate will depend on the application. Low ratios result in a material that is very thick but may not absorb as much heat as a very high ratio mixture which can have low viscosity and very high water content.

The resulting hydrogel will be held in a hydrophobic structure such as a foil pouch. The advantage of a foil pouch is that it may be constructed of the same materials and on similar equipment as the lithium polymer cell pouches. This may reduce manufacturing costs. Foil will retain the water content ratio, and therefore will maintain the viscosity of the hydrogel for very long periods.

The hydrophobic structure may include internal structures to spread-out and maintain mechanical integrity of the hydrogel. For example a porous sponge material may be used, or the structure may be divided up into a multitude of smaller segments each containing hydrogel.

In another embodiment of the invention the hydrophilic material can be natural cotton, sponge or other material that does not contain polymers. In these cases the hydrophobic structure is used to ensure the water is kept in close contact with the energy storage cell.

In another embodiment of the invention the thermal barrier structure includes a low viscosity, non-flammable energy absorbing material which has an atmospheric boiling point above the maximum operating temperature of the battery and below the thermal runaway temperature of the battery, and such energy absorbing material is encased in a retaining structure which retains mechanical integrity at temperatures above the atmospheric boiling point of the energy absorbing material.

In another embodiment of the invention, the hydrophobic retaining structure may include in the design an intentional venting ability that will relieve excessive pressure build-up within the structure which could affect the atmospheric boiling point of the energy absorbing material.

### DESCRIPTION OF THE FIGURES

FIG. 1 shows a cross section of the thermal barrier system.

FIG. 2 is a graph of the expected performance of the thermal barrier system.

FIG. 3 shows a cross-section the thermal barrier system under three different operating scenarios.

FIG. 4 shows a cross-section of five different construction methods for the thermal barrier system.

FIG. 5 shows the thermal barrier system installed in a battery pack.

FIG. 6 shows the thermal barrier system installed in a battery pack with a single cell undergoing a thermal runaway condition.

FIG. 7 shows a battery pack in a case being touched by a user.

### DESCRIPTION OF A PREFERRED EMBODIMENT OF THE INVENTION

In a preferred embodiment, sodium polyacrylate is used as the hydrophilic substance and will be mixed at a ratio of about 1 part sodium polyacrylate to 99 parts water. From this point of view the result substance can be treated as essentially pure water from a thermodynamic point of view. Sodium polyacrylate also has the advantage of little or no health and safety concerns around humans. In particular the standard MSDN (Material Safety Data Sheet) lists health, flammability, reactivity, exposure and storage concerns all as “Zero” risk.

Water has a specific heat capacity Cp of about 4.2 J/gK where j is in joules, g is in grams and k is in degrees Kelvin or centigrade. Therefore, it will take 4.2 Joules of energy to raise 1 gram of water by 1 degree Kelvin (or centigrade). Water has one of the highest heat capacities for a liquid substance. Ammonia is another liquid with a high Cp of about 4.7 J/gK.

Aluminum only has a heat capacity Cp of about 0.9 J/gK and copper of 0.4 J/gK.

Solid paraffin wax has a heat capacity Cp of about 2.5 J/gK and liquid paraffin of about 1.7 J/gK.

The latent heat of vaporization Lv of water is about 2260 J/g. Therefore, when water transitions from being a liquid to a gas, it will absorb about 2260 joules of energy per gram. Water will remain at the atmospheric boiling point Tb, about 100° C., until all of the water has been converted to vapour, assuming standard atmospheric pressures.

Considering a Lithium energy storage cell, the maximum short term operating temperature may be specified as 70° C. and the thermal runaway temperature can be as low as 150° C. depending on the depending on the chemistry and the manufacturer.

Denoting maximum operating temperature as Tmax and minimum thermal runaway temperature as Trun, and the amount of thermal absorption material as M in grams, and also, assuming that the vapour produced at the heat of vaporization temperature Lv, the following formula can be used to calculate the amount of energy Ea that will be absorbed as the thermal material is heated from Tmax to Tb.

Provided Trun>Tb:

Ea=(((Tb−Tmax)×Cp)+Lv)×M

One gram of a mixture of one part sodium polyacrylate with 99 parts water, when used with a lithium battery that has a maximum operating temperature of 70° C. and the thermal runaway temperature of 150° C. would therefore be able to absorb 2386 Joules of energy per gram.

Ea=(((100−70)×4.2)+2260)=2386 J/g

If the lithium battery has an energy density of 200 watt-hours-per-kilogram. The energy density of the battery Ed is therefore capable of releasing 720 joules of energy.

In order to absorb all of the energy of the battery, the amount of energy absorbing material Mr is therefore Ed/Ea grams per gram.

Mr=720/2386=0.3 grams per gram.

Therefore, as a worst-case, a 1 kg battery may require the addition of 300 g of energy absorbing material in order to absorb all of the energy released by the battery during a fault situation. In reality a battery will require much less material because lithium battery thermal runaway temperatures typically increase as the battery becomes discharged. Also, the other cells in the battery pack will themselves absorb a significant amount of thermal energy as they are raised to their thermal runaway temperature.

Assuming the heat capacity of a lithium battery to be mostly dependent on the graphite, aluminum and copper materials that make up the electrode structures, it can be assumed that a lithium battery has a heat capacity Cp of about 0.7 J/gK. Then the energy absorption Ea of the non-faulted lithium cells as they are heated from their maximum operating point to the thermal runaway point could be approximated as:

Ea=((Trun−Tmax)×Cp)

For the lithium battery used in the previous example:

Ea=((150−70)×0.7)=56 J/g

If we then assume that, on average, the lithium cells will have a mass that is 10 times higher than the energy absorption material, and that we further assume that there will be one cell on each side of the faulted battery, then the total energy absorption contributed by the non-faulted cells in the immediate vicinity of the faulted cell would be 20 times the Ea value per gram of energy absorption materials.

If the energy absorption materials are used between each cell in the battery pack, then we can assume that the faulted cell will have two energy absorption elements associated with it (one on each side) and that each non faulted cell will also have an extra energy absorption element associated with it. Therefore, a total of four energy absorption elements will be present per faulted cell.

Therefore the total energy absorption Et per gram of energy absorption material disposed between each cell in the battery pack can be multiplied by at least a factor of 4, where Eam is the energy absorption ability of the material and Eac is the energy absorption of the lithium cells, the total formula would become:

Et=(4×Eam)+(20×Eac)=(4×2386)+(20×56)=10664 J/g

Therefore, returning to the formula for calculating grams-per-gram of material we would find:

Mr=720/10664=0.07 grams per gram.

Therefore, as a more reasonable case, a 1 kg battery may require the addition of 70 g of energy absorbing material in order to prevent thermal runaway propagation within the battery.

For a battery system with an energy capacity of 200 Wh/kg, which is a primary competitive distinction between various energy storage technologies, it is expected that a battery pack containing thermal runaway propagation barriers may see the energy density drop to about 187 Wh/kg, which, for most applications, is an insignificant difference, especially when considered against the dramatic increase in safety.

Other hydrophilic compounds can also be used including Polyacrylamide, for example C3H5NO in very long chains. Polyacrylamide-co-acrylic acid can also be super-absorbent and therefore meet the needs of providing thermal barrier. In particular, the addition of co-acrylics or other dopants can allow the atmospheric boiling point to be adjusted to higher or lower boiling points, therefore being tailored to suit the particular thermal operation and thermal runaway points of the given battery system.

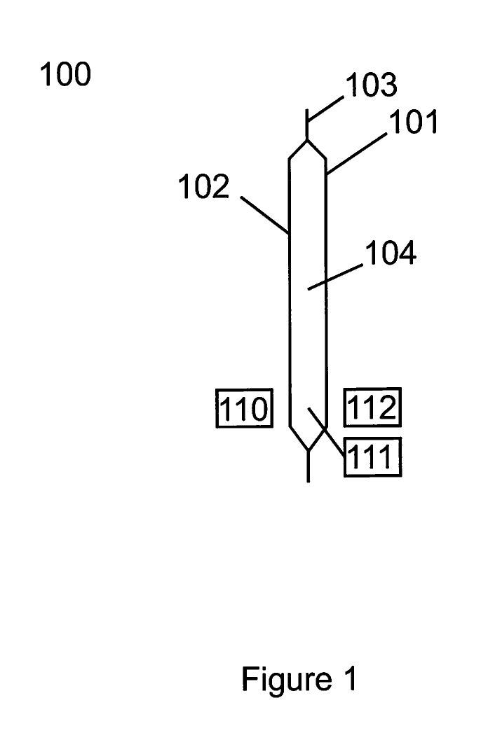

Referring to FIG. 1, a thermal barrier system (100) is shown in cross-section, which is constructed from two hydrophobic sheets. A first hydrophobic sheet (102) and a second hydrophobic sheet (101) are bonded together at a seal area (103) around the perimeter of the pouch. The interior of the pouch is filled with the hydrophilic material (104).

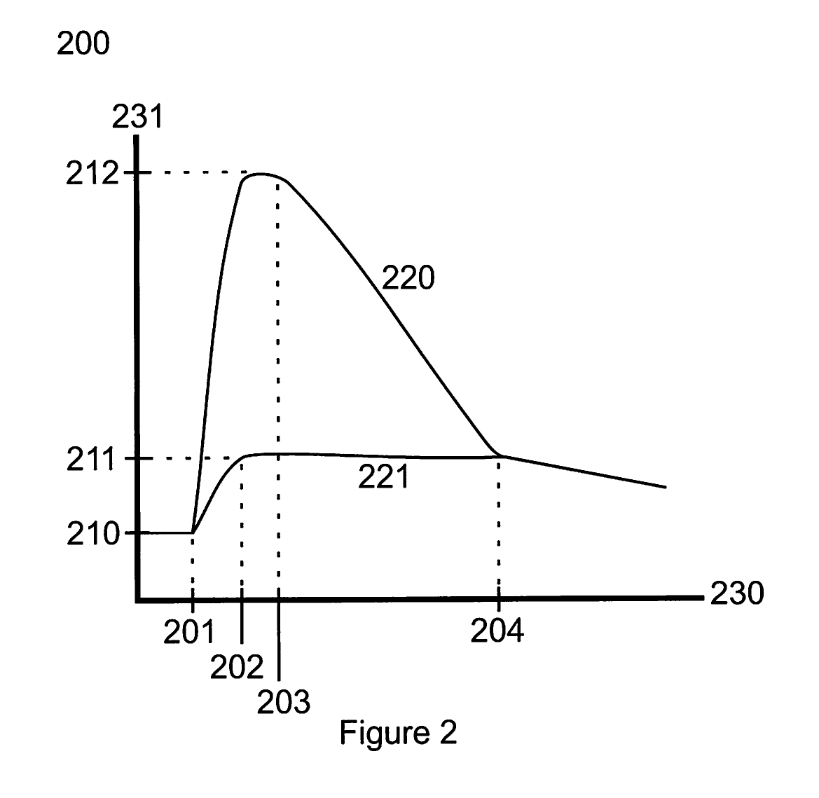

Referring now to both FIG. 1 and FIG. 2 wherein FIG. 2 includes a vertical axis for temperature (231) and a horizontal axis for time (230). When a hot body, such as a faulted lithium cell, is in contact with a first area (110) of the thermal barrier system (100), the hydrophilic material (104) will at first absorb the heat from the faulted lithium cell. The hydrophilic material in the region of the heat (111) will rise in temperature until it reaches its atmospheric boiling point. In FIG. 2, a graph (200) includes the ambient operating temperature (210) of the system. A fault occurs at time (201) at which point the temperature of the faulted battery (FIG. 1-110, FIG. 2 plot line 220) will rapidly rise. The un-faulted lithium cell (112) is located on the opposite side of the thermal barrier. The un-faulted lithium cell (FIG. 1-112. FIG. 2 plot line 221) will rise in temperature as the hydrophilic material (111) also rises in temperature. The un-faulted cell temperature rise will lag behind the rise in temperature of the faulted cell due to thermal absorption of the hydrophilic material and due to thermal propagation delay through the hydrophilic material and the thermal mass of the un-faulted lithium cell itself.

Once the hydrophilic material (111) reaches its atmospheric boiling point, the temperature seen by the un-faulted lithium cell will stabilize (FIG. 2, time 202, temperature 211). The temperature of the faulted cell (FIG. 1-110. FIG. 2 plot line 220) may continue to rise to a point where the faulted cell rate of energy production equals the rate of absorption of energy by all materials that surround the faulted cell, including all packaging, electronics and the thermal barrier material itself. The maximum temperature (212) may be above or below the thermal runaway temperature of the faulted cell. Eventually the faulted cell will exhaust its energy capacity at time (203) and the temperature will then begin to fall. The thermal energy of the faulted cell will continue to be absorbed by the thermal barrier material until the temperature of the faulted cell is equal to the temperature of the thermal barrier material at time (204). The temperature of the entire system will then gradually fall as the energy is absorbed and radiated into the ambient environment.

Provided the thermal runaway temperature of the un-faulted lithium cell is lower than the atmospheric boiling point of the thermal barrier material. FIG. 2 demonstrates that the temperature of the un-faulted lithium cell (plot line 221) does not exceed the atmospheric boiling point (211) of the thermal barrier material.

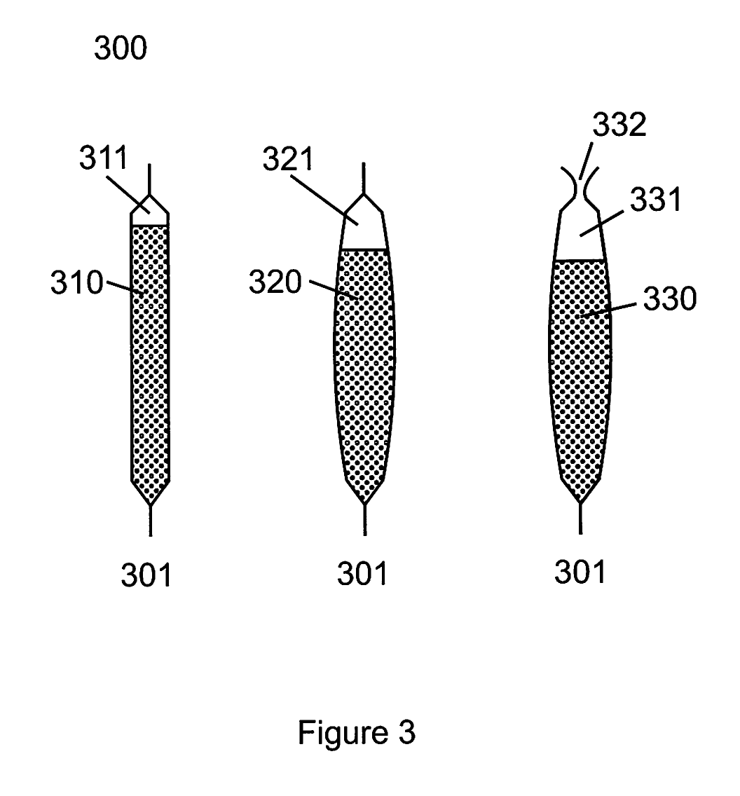

FIG. 3 shows three examples of the thermal barrier system (300) during three different modes of operation. The normal state (301) is similar to the concept shown in FIG. 1. The thermal barrier material (310) which preferably consists of a hydrophilic polymer that is 99% water is shown occupying most of the pouch. A small void (311) may be present which will allow normally expected levels of expansion and contraction of the thermal barrier material to take place without significantly affecting the pressure inside the pouch.

The pouch may swell as shown in the hot-state (302). When exposed to a temperature which exceeds the atmospheric boiling point of the thermal barrier material (320) the pressure inside the pouch will increase which may cause swelling. In addition, vapour may evolve as the thermal barrier material undergoes vaporization, this may cause the void area (321) to increase in size.

The pouch may continue to swell as energy is absorbed from a faulted cell. The pouch may enter a vented state (303) when the vapour pressure inside the pouch exceeds the design capacity of the pouch itself. Elevated pressures inside the pouch may cause the boiling point of the thermal barrier material (330) to increase unacceptably. Therefore, the pouch may be designed with a specific weak area (332) which is designed to open at a specific pressure level in order to reduce pressure inside the pouch. As pressure instantly drops inside the pouch, the thermal barrier material will be super-heated when compared to its regular atmospheric boiling point. As a result, there will be a short period of higher than normal energy absorption following such venting action.

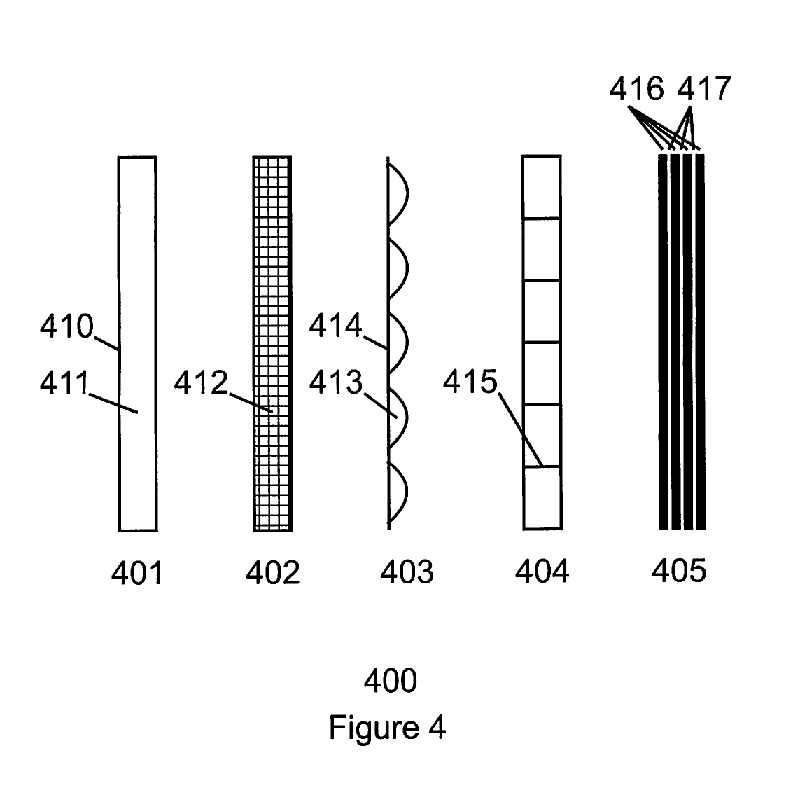

FIG. 4 shows five examples of packaging methods for various thermal barrier systems (400) all shown in cross-section. The basic thermal barrier system (401) includes a hydrophobic outer material which may be in the form of a pouch, foil; plastic laminate; blow-molded case, metal shell, or any other method that retains the hydrophilic material (411) contained and prevents it from drying out during normal operation.

A modified thermal barrier system (402) is shown with the pouch containing an internal support structure (412) which may be composed of a sponge, net, woven material, cotton, nylon or any other material that will ensure the hydrophilic material remains in its intended location. Without the internal support structure (412) the hydrophilic material may tend to pool at the bottom of the pouch due to gravity. This effect would be most pronounced if the walls of the pouch are highly flexible and the hydrophilic material is of low viscosity. The support material may not be required if the hydrophilic material is of high enough viscosity to support itself, or if the barrier is always installed in an orientation that prevents gravitational effects from displacing the hydrophilic material.

The thermal barrier may be constructed in a bubble-wrap form (403) where fluid filled blisters (413) are formed with sealed areas (414) between each blister. The blisters ensure the hydrophilic material remains constrained to a small localized area of the lithium cell; it also ensures that the loss of one blister due to mechanical damage will not significantly impact the operation of the entire sheet which may contain thousands of blisters.

The thermal barrier may be constructed with separated regions (404) isolated by intermediate walls (415) disposed between each region. This barrier is similar to the bubble-wrap form (403) with the exception that a higher volume of hydrophilic material and better surface coverage may be achieved.

The thermal barrier may be constructed by utilizing a laminated concept (405). This concept works best with high viscosity hydrophilic materials. The high viscosity hydrophilic material (417) is disposed between alternating sheets of hydrophobic material (416). If the thickness of the laminates is made sufficiently thin compared to the overall area of the laminates, the system may require no other mechanical seals or supports, otherwise the edges of the laminate may be sealed with glue, tape, paint or by other conventional methods.

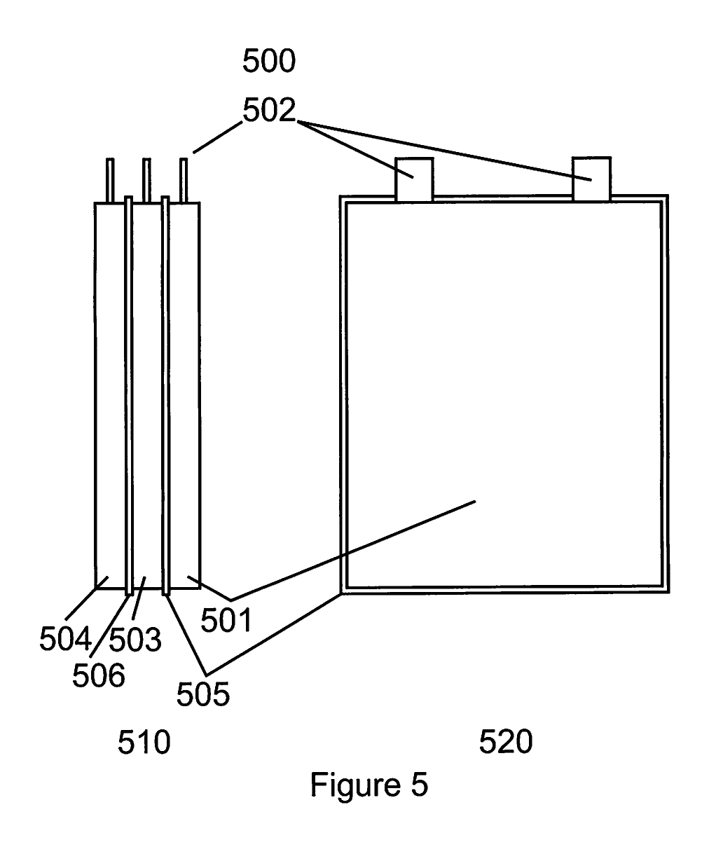

FIG. 5 shows a preferred embodiment installed in a three cell battery pack (500). The side cross-section (510) of the battery pack shows a lithium polymer cell (501) which includes an electrical connection tab (502). Additional cells (501, 504) are included in the pack. The thermal barriers (505, 506) are installed between each cell (501, 503, and 504). A front cross-section (520) of the battery pack shows the lithium polymer cell (501) in front of the thermal barrier (505) and shows two electrical connection tabs (502) on the cell.

In the case of the previous descriptions of a faulted lithium cell, the faulted cell (503) would try to transfer heat to the neighbouring cells (501, 504) but will be prevented from transmitting temperatures beyond the atmospheric boiling point of the hydrophilic material due to the thermal barriers (505, 506).

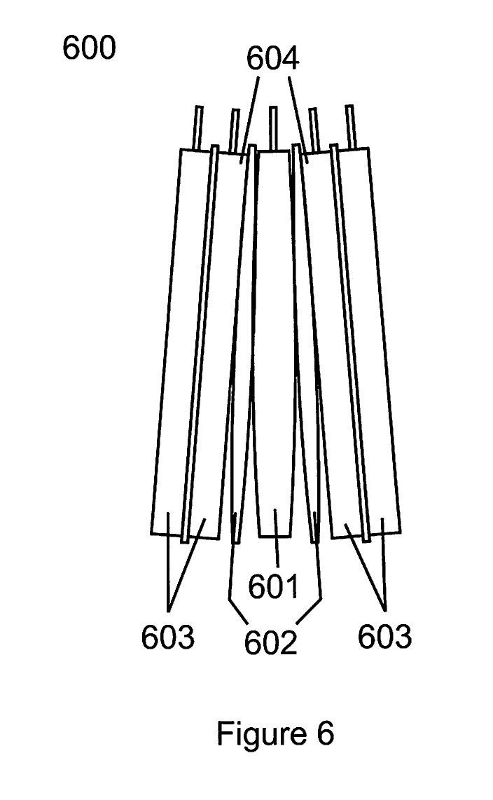

FIG. 6 shows a side cross-section of a faulted five-cell lithium battery pack (600). In this case the faulted cell (601) has increased in temperature and is starting to swell; this is common for lithium polymer cells in foil pouches. The thermal barriers (602) on each side of the faulted cell have also reached their boiling temperatures and are therefore evolving vapour which is causing them to intentionally swell. In this example the thermal barriers are made in a similar pouch format to the lithium cells themselves. This battery pack includes four un-faulted cells (603) which remain at or below the atmospheric boiling point of the hydrophilic material and therefore they are not swelling. The two thermal barriers (604) which separate the un-faulted cells will continue to cool the un-faulted cells due to their contact with one side of each un-faulted cell. Provided the battery pack outer housing provides for some expansion room, it can be seen in FIG. 6 that allowing the thermal barriers to swell will also cause the un-faulted cells to be physically pushed away from the faulted cell. This increased gap will further reduce the conduction of heat into the un-faulted cells and will further reduce the probability of thermal runaway propagation through the pack.

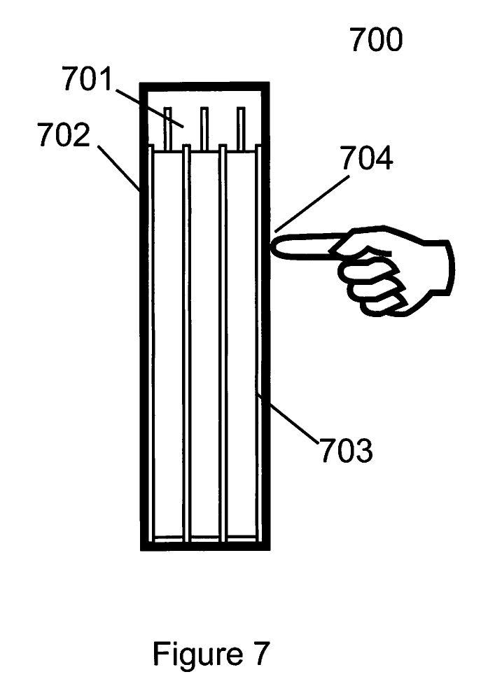

FIG. 7 shows a typical complete battery pack system (700) made up of three cells (701) installed within housing (702). The cells each have the hydrophilic polymer thermal barrier installed between them. In addition, a hydrophilic polymer thermal barrier is installed between the outer cells and the casing (703). In the even of a thermal runaway situation, or any situation where the temperature of the cells within the battery pack housing (702) rises above the atmospheric boiling temperature, the thermal barrier between the cells and the housing (702) will ensure that the housing temperature does not rise above the atmospheric boiling, temperature. Contact with the housing by an operator (704) or by neighbouring equipment (including other complete battery packs) will be dramatically safer due to the relatively low temperature of the housing compared with the possible high temperature of the faulted cells within the battery housing.

An advantage of the hydrophilic polymer thermal barrier is that it will conduct thermal energy up to the point where it reaches the atmospheric boiling temperature. During normal operation, waste heat generated inside the housing (702) can still easily escape through the thermal barrier material. It is only in cases where the temperature is very high that thermal propagation rates will fall. If it is required that a battery be constructed with guaranteed housing temperatures below a certain point (for example 85° C.) then the polymer can be doped with other chemicals in order to reduce the atmospheric boiling temperature to the desired temperature.

Mixing different polymers at different areas of the battery pack and even within the same thermal barrier itself (through the use of packaging such as those shown in FIG. 4 (403, 404 or 405) can allow the battery pack thermal characteristics to be optimized for safety and performance.

The thermal barrier system may also be applied to electronics to prevent overheated components from damaging surrounding systems. In particular, where a circuit board is placed in close proximity to a device that is highly temperature sensitive, such as a lithium polymer cell, the thermal barrier will allow normal heat propagation to occur up to the atmospheric boiling temperature of the thermal barrier.

The thermal barrier can also reduce thermal signatures, often called an infrared signature that may occur in equipment due to a hot spot. For defense systems these thermal signatures can draw unwanted attention and provide a target for weapons.

Although the description above contains much specificity, these should not be construed as limiting the scope of the invention but as merely providing illustrations of the presently preferred embodiment of this invention. Thus the scope of the invention should be determined by the appended claims and their legal equivalents.

What is claimed is:

1. A thermal barrier system for a battery pack comprising a plurality of battery cells, said thermal barrier system comprising a thermal barrier disposed between each of said plurality of battery cells within said battery pack, and wherein:
a. Said thermal barrier has a cross-sectional area that is at least equal to an adjacent battery cell; and,
b. The thermal barrier contains a thermal absorbing material in a sufficient quantity to absorb heat released from a faulted battery.

2. The system of claim 1 wherein the thermal barrier comprises a hydrophilic polymer.

3. The system of claim 2 wherein the hydrophilic polymer is selected a group of polymers comprising acrylics and amine-functional polymers.

4. The system of claim 3 wherein said acrylics comprise at least acrylic acid, acrylamide and maleic anhydride polymers and co-polymers.

5. The system of claim 3 wherein said amine-functional polymers comprise at least allylamine, ethyleneimine and oxazoline.

6. The system of claim 3 wherein the hydrophilic polymer is one of a sodium polyacrylate and a polyacrylamide-co-acrylic acid.

7. The system of claim 6 wherein the hydrophilic polymer comprises a hydrogel.

8. The system of claim 7 wherein the thermal barrier comprises an envelope comprising a hydrophobic material containing said hydrogel.

9. The system of claim 8 wherein said hydrophobic material is a foil pouch.

10. The system of claim 9 wherein said foil pouch contains a supporting structure comprising a porous sponge material.

11. The system of claim 10 wherein said supporting structure comprises a plurality of independent cells each containing the hydrogel.

12. The system of claim 10 wherein the supporting structure comprises a natural cotton material.

13. The system of claim 12 wherein the thermal absorbing material has at least the following properties: non-flammable, low-viscosity and an atmospheric boiling point higher than a maximum operating temperature of the battery pack and lower than the a thermal-runaway temperature of the battery pack.

14. The system of claim 13 wherein the thermal absorbing material is doped with a dopant to vary said atmospheric boiling point.

15. The system of claim 14 wherein the dopant is a co-acrylic.

16. The system of claim 1 wherein said sufficient quantity of thermal absorbing material is approximately 0.07 grams of thermal absorbing material per gram of battery material.

17. The system of claim 1 wherein the thermal barrier:
a. has a first normal state, a second hot state and a third vented state;
b. comprises a thermal absorbing material comprising 99% water;
c. is disposed between the electrochemical cells in a battery and the battery housing;
d. freely transmits thermal energy below an atmospheric boiling temperature;
e. resists the transmission of thermal energy above an atmospheric boiling temperature; and,
f. includes a void for expansion and contraction of the thermal absorbing material contained therein.

18. The system of claim 17 wherein when in said hot state the thermal absorbing material exceeds its atmospheric boiling point and evaporates thereby increasing the size of said void.

19. The system of claim 18 wherein when in said third vented state the thermal barrier envelope is breached for pressure release.

20. The system of claim 19 wherein the thermal barrier envelope includes a weak area to promote breaching when pressure within the thermal barrier envelope exceeds a predetermined pressure.
